(19) United States
(12) Patent Application Publication
(10) Pub. No.: US 2025/0003829 A1
(43) Pub. Date: Jan. 2, 2025

(54) INTELLIGENT BRIDGE CONDITION MONITORING

(71) Applicant: INTERNATIONAL BUSINESS MACHINES CORPORATION, Armonk, NY (US)

(72) Inventors: Neil Delima, Scarborough (CA); Su Liu, Austin, TX (US); Hamid Majdabadi, OTTAWA (CA)

(21) Appl. No.: 18/215,861

(22) Filed: Jun. 29, 2023

(51) Int. Cl. G01M 5/00

(52) U.S. Cl. CPC G01M 5/0066; G01M 5/0008; G01M 5/0033

(57) ABSTRACT

A method, system, and computer program product are configured to: determine different baseline vibration patterns of a bridge for different vehicle categories; obtain vibration data from a vehicle crossing the bridge; classify the vehicle into a respective one of the vehicle categories; select a respective one of the baseline vibration patterns based on the respective one of the vehicle categories; determine a difference between the vibration data collected from the vehicle and the respective one of the baseline vibration patterns; and in response to the difference exceeding a predefined threshold, perform a predefined remediation action.

### BACKGROUND

Aspects of the present invention relate generally to monitoring physical infrastructure assets and, more particularly, to intelligent bridge condition monitoring using vibration data derived from vehicle sensors.

There are over 600,000 bridges in the United States and almost 13% have some sort of structural damage. Currently, about 42% of bridges in the United States are at least 50 years old. Moreover, about 8% of bridges in the United States are in poor condition, meaning that they are considered structurally deficient in some aspect.

### SUMMARY

In a first aspect of the invention, there is a computer-implemented method including: determining, by a processor set, different baseline vibration patterns of a bridge for different vehicle categories; obtaining, by the processor set, vibration data from a vehicle crossing the bridge; classifying, by the processor set, the vehicle into a respective one of the vehicle categories; selecting, by the processor set, a respective one of the baseline vibration patterns based on the respective one of the vehicle categories; determining, by the processor set, a difference between the vibration data collected from the vehicle and the respective one of the baseline vibration patterns; and in response to the difference exceeding a predefined threshold, performing, by the processor set, a predefined remediation action.

In another aspect of the invention, there is a computer program product including one or more computer readable storage media having program instructions collectively stored on the one or more computer readable storage media. The program instructions are executable to: determine different baseline vibration patterns of a bridge for different vehicle categories; obtain vibration data from a vehicle crossing the bridge; classify the vehicle into a respective one of the vehicle categories; select a respective one of the baseline vibration patterns based on the respective one of the vehicle categories; determine a difference between the vibration data collected from the vehicle and the respective one of the baseline vibration patterns; and in response to the difference exceeding a predefined threshold, perform a predefined remediation action.

In another aspect of the invention, there is a system including a processor set, one or more computer readable storage media, and program instructions collectively stored on the one or more computer readable storage media. The program instructions are executable to: determine different baseline vibration patterns of a bridge for different vehicle categories; obtain vibration data from a vehicle crossing the bridge; classify the vehicle into a respective one of the vehicle categories; select a respective one of the baseline vibration patterns based on the respective one of the vehicle categories; determine a difference between the vibration data collected from the vehicle and the respective one of the baseline vibration patterns; and in response to the difference exceeding a predefined threshold, perform a predefined remediation action.

In a first aspect of the invention, there is a computer-implemented method that includes generating a trained machine learning model by: in response to receiving information associated with a plurality of vehicles crossing a structure of interest, classifying each vehicle into one of a plurality of categories including a type and an associated subclass including make and model; identifying vehicles crossing the structure of a predetermined frequency as a reliable data collection source to form a set of identified vehicles; collecting vehicle vibration data as telematic data including context from embedded vibration sensors in each of the vehicles of the set of identified vehicles; filtering the telematic data of each vehicle using the context, and predetermined criteria, to eliminate variations caused by predetermined factors of disinterest; generating a vibration pattern as a baseline associated with the structure of interest; and saving the baseline for each structure of interest in a repository. The method further includes: in response to monitoring vehicle traffic crossing one or more of the structures of interest, collecting new telematic data including context for any of the vehicles of the set of identified vehicles associated with a crossing; comparing the new telematic data including context from a same type of vehicle under a same context with the baseline; and in response to determining a difference between the baseline and the new telematic data including context exceeds a predetermined threshold, sending an alert.

In another aspect of the invention, there is a system including a processor set, one or more computer readable storage media, and program instructions collectively stored on the one or more computer readable storage media. The program instructions are executable to generate a trained machine learning model by: in response to receiving information associated with a plurality of vehicles crossing a structure of interest, classify each vehicle into one of a plurality of categories including a type and an associated subclass including make and model; identify vehicles crossing the structure of a predetermined frequency as a reliable data collection source to form a set of identified vehicles; collect vehicle vibration data as telematic data including context from embedded vibration sensors in each of the vehicles of the set of identified vehicles; filter the telematic data of each vehicle using the context, and predetermined criteria, to eliminate variations caused by predetermined factors of disinterest; generate a vibration pattern as a baseline associated with the structure of interest; and save the baseline for each structure of interest in a repository. The program instructions are executable to: in response to monitoring vehicle traffic crossing one or more of the structures of interest, collect new telematic data including context for any of the vehicles of the set of identified vehicles associated with a crossing; compare the new telematic data including context from a same type of vehicle under a same context with the baseline; and in response to determining a difference between the baseline and the new telematic data including context exceeds a predetermined threshold, send an alert.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIGS. 3-7 show flowcharts exemplary methods in accordance with aspects of the present invention.

### DETAILED DESCRIPTION

Aspects of the present invention relate generally to monitoring physical infrastructure assets and, more particularly, to intelligent bridge condition monitoring using vibration data derived from vehicle sensors. According to aspects of the invention, a method, system, and computer program product are configured to: determine different baseline vibration patterns of a bridge for different vehicle categories; obtain vibration data from a vehicle crossing the bridge; classify the vehicle into a respective one of the vehicle categories; select a respective one of the baseline vibration patterns based on the respective one of the vehicle categories; determine a difference between the vibration data collected from the vehicle and the respective one of the baseline vibration patterns; and in response to the difference exceeding a predefined threshold, perform a predefined remediation action.

Around the United States, more than one in three bridges are crumbling and need repair. Continuous corrosion and fatigue can lead to loss of the load carrying capacity and a major collapse. About half of collapsed bridges are structurally deficient as a result of age, excessive loads, extreme weather, inadequate maintenance, and other aspects.

Technologies such as infrared thermography, ground-penetrating radar, and remotely operated surveillance devices like flying and submersible drones are being deployed to assess bridge conditions and to facilitate safer, more efficient engineering decisions. Such solutions are highly resource and labor intensive and, thus, are not economically attractive. Other field methods to assess bridge damage include visual inspection, dye penetrant testing, magnetic particle testing, and ultrasonic techniques. These field methods can miss structural problems or fail to catch them in time to prevent a catastrophe. Moreover, all these methods only gather data during site visits with the specialized equipment and, thus, do not provide around-the-clock monitoring.

In addition to the above-noted technologies, engineers are designing “living bridges” where sensors are being embedded into new and existing structures to provide continuous feedback on structural conditions. However, these solutions are not economically attractive because they involve high costs of installing sensor systems in bridges and maintaining the installed sensor systems. Moreover, these solutions generate a large amount of unwanted noisy data and do not effectively scale to manage and monitor the enormous, 617,000 and growing number bridges across the United States alone.

Therefore, there exists a need for a way to proactively monitor the structural integrity of bridges in an efficient way without having to instrument every bridge with sensors. There exists a need for a way to sift through the noise generated from a large amount of Internet of Things (IoT) vibration data to select the most reliable data source and detect anomalies in vibration patterns linked to structural integrity.

Implementations of the invention address these needs by providing a method, system, and computer program product for Intelligent Bridge Condition Monitoring (IBCM) that leverages selective vehicle telematic data from embedded vehicle vibration sensors to dynamically check the structural conditions of registered bridges by detecting anomalies in vibration patterns. A method for performing IBCM in accordance with aspects of the invention includes a configuring phase, a training phase, and a real time service phase. In embodiments, a configuring phase comprises: defining a framework for supporting IBCM; and defining a secure data structure for tracking and saving the data of IBCM. In embodiments, a training phase comprises: monitoring the traffic crossing the monitored bridges; classifying the monitored vehicles into different categories and subclasses; selecting certain vehicles that regularly cross the same bridge as the reliable data collection source; collecting the vehicle vibration data with context from the embedded sensors in those selected vehicles; filtering data according to the context (e.g., only one vehicle on the bridge) and eliminating potential variations caused by other factors (e.g., other vehicles or weather); and generating a normal bridge vibration pattern and saving it into a database for each bridge. In embodiments, a real time service phase comprises: monitoring the traffic crossing the monitored bridges; collecting the vehicle vibration data with context from the embedded sensors in those selected vehicles; comparing the new received bridge vibration data from same type of vehicle under same context with the generated normal bridge vibration pattern; and sending out an alert if difference reaches a predefined threshold.

Aspects of the present disclosure provide for a computer-implemented method, system, and computer program product for performing a process of structural monitoring. In embodiments, the process of structural monitoring includes generating a trained machine learning model by: in response to receiving information associated with a plurality of vehicles crossing a structure of interest, classifying each vehicle into one of a plurality of categories including a type and an associated subclass including make and model; identifying vehicles crossing the structure of a predetermined frequency as a reliable data collection source to form a set of identified vehicles; collecting vehicle vibration data as telematic data including context from embedded vibration sensors in each of the vehicles of the set of identified vehicles; filtering the telematic data of each vehicle using the context, and predetermined criteria, to eliminate variations caused by predetermined factors of disinterest; generating a vibration pattern as a baseline associated with the structure of interest; and saving the baseline for each structure of interest in a repository. In embodiments, the process of structural monitoring includes, in response to monitoring vehicle traffic crossing one or more of the structures of interest, collecting new telematic data including context for any of the vehicles of the set of identified vehicles associated with a crossing. In embodiments, the process of structural monitoring includes comparing the new telematic data including context from a same type of vehicle under a same context with the baseline. In embodiments, the process of structural monitoring includes, in response to determining a difference between the baseline and the new telematic data including context exceeds a predetermined threshold, sending an alert.

Implementations of the invention are necessarily rooted in computer technology. In one example, the step of generating a trained machine learning is computer-based and cannot be performed in the human mind. Training and using a machine learning model are, by definition, performed by a computer and cannot practically be performed in the human mind (or with pen and paper) due to the complexity and massive amounts of calculations involved. For example, an artificial neural network may have millions or even billions of weights that represent connections between nodes in different layers of the model. Values of these weights are adjusted, e.g., via backpropagation or stochastic gradient descent, when training the model and are utilized in calculations when using the trained model to generate an output in real time (or near real time). Given this scale and complexity, it is simply not possible for the human mind, or for a person using pen and paper, to perform the number of calculations involved in training and/or using a machine learning model.

In another example, the step of obtaining vibration data from a vehicle crossing the bridge is necessary performed using a particular machine (e.g., vibration sensors embedded in a vehicle) and using computer-based (e.g., network) communication.

It should be understood that, to the extent implementations of the invention collect, store, or employ personal information provided by, or obtained from, individuals (for example, sensor data from a personal vehicle) such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as structural monitoring code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

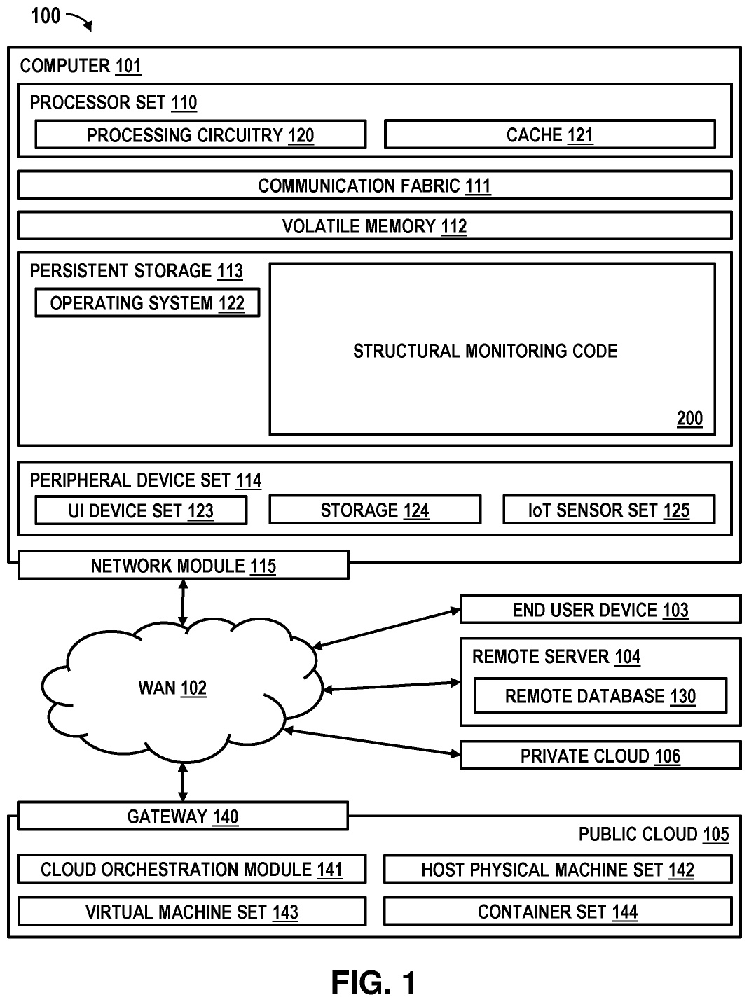

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

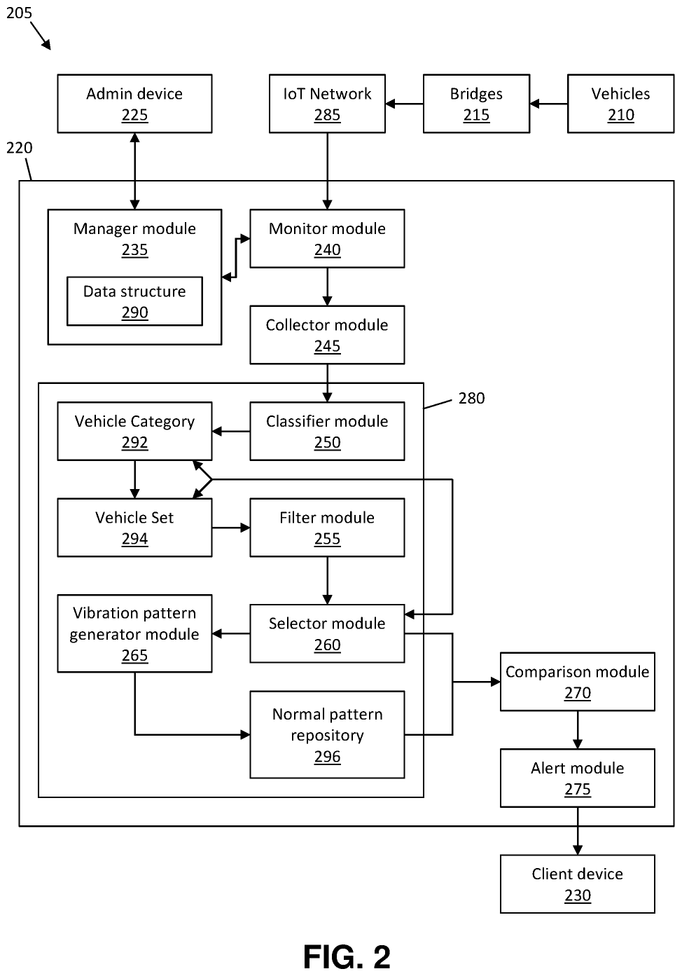

FIG. 2 shows a block diagram of an exemplary environment 205 in accordance with aspects of the invention. In embodiments, the environment 205 includes vehicles 210, bridges 215, a monitoring server 220, an admin device 225, and a client device 230.

The vehicles 210 include land vehicles such as automobiles, trucks, motorcycles, busses, etc. Each of the vehicles 210 is equipped with at least one sensor that collects vibration data or data from which vibration data can be derived. In one example, the sensor comprises an accelerometer installed on the vehicle. In this example, the accelerometer may be embedded in a portion of the suspension of the vehicle, preferably a portion of the suspension between the spring and the wheel, e.g., at the lower end of a strut. By locating the accelerometer at the lower end of the strut, the accelerometer is exposed to the full vibrational load experienced by the wheel before the load is attenuated by the spring attached to the strut. In another example, the sensor comprises a sensor that detects an amount of travel of a portion of the suspension of the vehicle. Other vibrational sensors that are used by the suspension system of the vehicle may be used. The sensors may be part of a telematics platform of the vehicle. The telematics platform can comprise sensors that are integrated with the vehicle to collect data about the vehicle. The telematics platform can transmit that data to a cloud-based server.

The bridges 215 include structures that carry a road or other type of path across a river, ravine, road, railroad, or other obstacle. The bridges 215 are configured to be driven on by one or more of the vehicles 210. In embodiments, each of the bridges 215 has a deck (also called deck area, decking, or decking area) upon which one or more of the vehicles 210 travel. Examples of types of the bridges 215 include: arch bridge, beam bridge, cable-stayed bridge, cantilever bridge, suspension bridge, truss bridge, tied arch bridge.

The admin device 225 comprises a computing device, such as a desktop computer, laptop computer, workstation, etc., that an administrative user utilizes to communicate with the monitoring server 220. There may be one or more admin devices 225 that communicate with the monitoring server 220, and each may comprise an instance of the EUD 103 of FIG. 1.

The client device 225 comprises a computing device, such as a desktop computer, laptop computer, workstation, tablet computer, smartphone, etc., that an end user utilizes to communicate with the monitoring server 220. There may be one or more user devices 225 that communicate with the monitoring server 220, and each may comprise an instance of the EUD 103 of FIG. 1.

The monitoring server 220 comprises a computing device or computing system that is configured to perform aspects of the invention as described herein. In one example, the monitoring server 220 comprises one or more instances of the computer 101 of FIG. 1. In another example, the monitoring server 220 comprises one or more virtual machines or containers running on one or more instances of the computer 101 of FIG. 1.

In embodiments, the monitoring server 220 of FIG. 2 comprises a manager module 235, monitor module 240, collector module 245, classifier module 250, filter module 255, selector module 260, vibration pattern generator module 265, comparison module 270, and alert module 275, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The monitoring server 220 may include additional or fewer modules than those shown in FIG. 2. In embodiments, separate modules may be integrated into a single module. In one example, the classifier module 250, filter module 255, selector module 260, and vibration pattern generator module 265 are comprised in a training module 280. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

With continued reference to the monitoring server 220, in embodiments the manager module 235 includes a data structure 290. In embodiments, the data structure 290 stores data collected and/or generated by the monitoring server 220. The data stored in the data structure 290 can include: a unique identifier for each of the bridges 215 (BridgeID); a unique identifier for each of the vehicles 210 (VehicleID); sensor data from one of the vehicles 210 traveling on one of the bridges 215 at a particular date and time (VibrationSignal, [BridgeID, [VehicleID], [Time]); a vibration wave derived from the sensor data (CurrentVibrationWave); data defining context associated with the sensor data (ContextInfoList); and a normal vibration pattern for each of the bridges 215 for different classifications of vehicles (NormalVibrationPattern). This example of data stored in the data structure 290 is not limiting, and other types of data and/or combinations of data may be used.

With continued reference to the monitoring server 220, in embodiments the training module 280 includes a normal pattern repository 296, which may be realized in persistent storage 113 of FIG. 1. In embodiments, the normal pattern repository 296 stores data defining a normal vibration pattern for each of the bridges 215 for each classification of the ones of the vehicles 210.

Still referring to FIG. 2, in accordance with aspects of the invention, the vehicles 210 transmit data collected by their sensors to the monitoring server 220 using network communication. The network communication may be generalized network communication, such as via the WAN 102 of FIG. 1. In another example, the network communication may be specialized network communication, such as via an Internet of Thing (IoT) network 285. In either example, the vehicles 210 may transmit their sensor data to the monitoring server 220 wirelessly and in real time, near real time, or at designated times or locations.

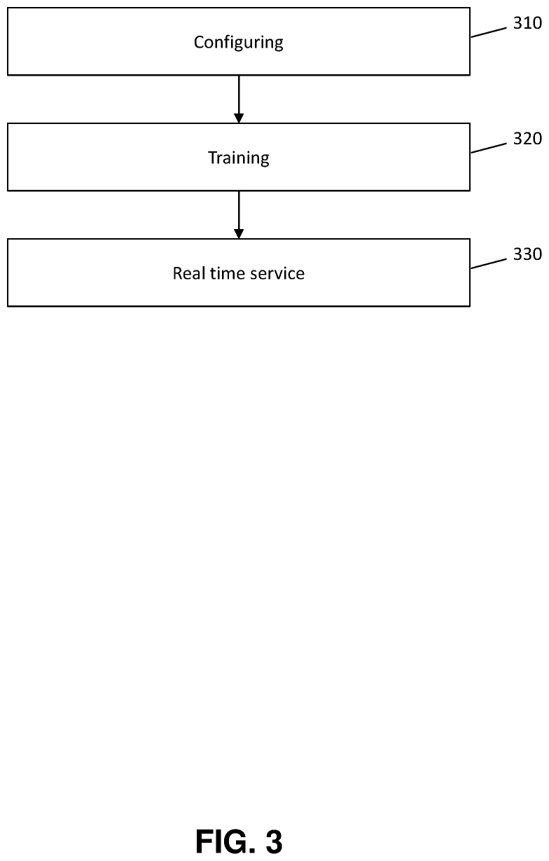

FIGS. 3-7 show flowcharts of exemplary methods in accordance with aspects of the present invention. Steps of the methods may be carried out in the environment of FIG. 2 and are described with reference to elements depicted in FIG. 2.

FIG. 3 shows a method in accordance with aspects of the invention that includes configuring at step 310, training at step 320, and real time service at step 330.

In embodiments, the configuring at step 310 comprises: defining a framework for supporting IBCM; and defining a secure data structure for tracking and saving the data of IBCM. In embodiments, the framework comprises the monitoring server 220 and the client device 230 of FIG. 2, and the secure data structure comprises the data structure 290 of FIG. 2.

Step 310 may comprise the manager module 235 creating a respective instance of the data structure 290 for each respective one of the bridges 215. The data structure 290 for a bridge may include a unique identifier for the bridge, type of the bridge, location of the bridge, standardized construction specifications of the bridge, name of company that built the bridge, year the bridge was built, building information model, etc. Plural data structures 290 for plural bridges may be created and maintained using an asset management platform.

Step 310 may additionally comprise linking the asset management platform to an asset monitoring platform. The asset monitoring platform may contain a data warehouse used to store asset monitoring data. The data warehouse may be secured and anonymized.

Step 310 may additionally comprise configuring the secured and anonymized data warehouse to store vehicle class and telematic data of the vehicles 210. In one example, the vehicle class data includes the make and model of a vehicle 210, and the telematic data includes the sensor data (e.g., vibration pattern) from a vehicle, the date and time when the sensor data was collected, and the location (e.g., global positioning system (GPS) location) where the sensor data was collected.

Step 310 may additionally comprise establishing secure connections by protocols to collect and transmit telematic data from the vehicles 210 into the data warehouse of the asset monitoring platform. This may include the development of data pipelines to extract, transform, and load data into the data warehouse. Protocols and tools such as MQTT, Kafka, Apache Beam, NiFi, or Apache Airflow may be used for this purpose. MQTT is a lightweight, publish-subscribe, machine to machine network protocol for message queue/message queuing service. It is designed for connections with remote locations that have devices with resource constraints or limited network bandwidth, such as in the Internet of Things. Kafka is a distributed event store and stream-processing platform. Apache Beam is an open-source unified programming model to define and execute data processing pipelines, including extract-transform-load (ETL), batch and stream processing. NiFi is a software project from the Apache Software Foundation designed to automate the flow of data between software systems. Apache Airflow is an open-source workflow management platform for data engineering pipelines. It started at Airbnb in October 2014 as a solution to manage the company's increasingly complex workflows.

Step 310 may additionally comprise establishing connections and protocols to collect local current and forecasted weather data for locations of each bridge data into the data warehouse of the asset monitoring platform.

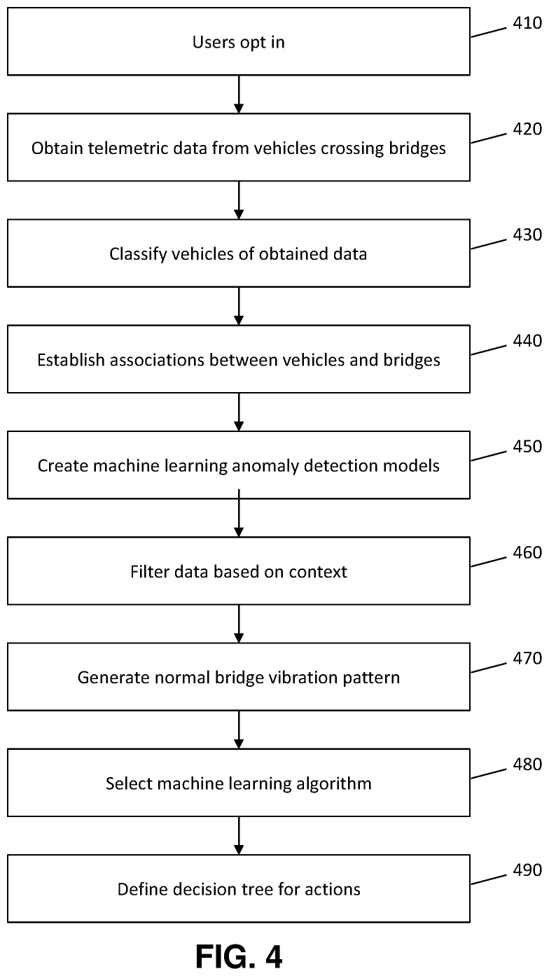

The method of FIG. 4 may be used to implement the training of step 320 of FIG. 3. In embodiments the training comprises: monitoring the traffic crossing the monitored bridges; classifying the monitored vehicles into different categories and subclasses; selecting certain vehicles that regularly cross the same bridge as the reliable data collection source; collecting the vehicle vibration data with context from the embedded sensors in those selected vehicles; filtering data according to the context (e.g., only one vehicle on the bridge) and eliminating potential variations caused by other factors (e.g., other vehicles or weather); and generating a normal bridge vibration pattern and saving it into a database for each bridge. In embodiments, and as described herein, the normal vibration pattern is for a specific vehicle or type of vehicle for each bridge.

At step 410, users of vehicles 210 opt in to having their telemetric data collected for training. Users may opt in by being provided with terms and conditions of the training and consenting by providing input via a website, app, written paperwork, etc.

At step 420, the system obtains telemetric data of vehicles 210 crossing bridges 215. The monitoring module 240 may monitor the GPS location of a vehicles 210 in real time or near real time and compare those locations to the locations of the bridges 215. Based on this location monitoring, when a vehicle 210 is determined to be driving on a bridge 215, the collector module 245 obtains the vibration data from the at least one sensor of the vehicle 210, e.g., via wireless network communication from the vehicle 210 to the sever 220. As described herein, each of the vehicles 210 is equipped with at least one sensor in or on its suspension, where the at least one sensor collects vibration data or data from which vibration data can be derived, and the data collected by this at least one sensor during the time that the vehicle 210 travels over the bridge 215 is transmitted from the vehicle 210 to the monitoring server 220. In embodiments, the data payload transmitted from the vehicle 210 to the monitoring server 220 includes a unique vehicle identifier of the vehicle 210 that may be used by the monitoring server 220 to look up the type, make, and model of the vehicle 210. In other embodiments, the data payload transmitted from the vehicle 210 to the monitoring server 220 includes a data defining the type, make, and model of the vehicle 210. The data obtained in this step may be saved in a data warehouse. The data may be obtained using streaming or extract-transform-load (ETL) methods.

At step 430, the system classifies the vehicles from which data was obtained. In embodiments, for the data obtained at step 420, the classifier module 250 classifies the monitored vehicles into different categories. In one example, the classification may be based on type, make, and model of the vehicles 210. In embodiments, the classifier module 250 stores the vibrational data for the vehicle with data from similarly classified vehicles in a vehicle category 292 data (as shown in FIG. 2).

At step 440, the system establishes associations between vehicles and bridges. In embodiments, the selector module 260 identifies a subset of the vehicles 210 that regularly cross the same one of the bridges 215, so as to establish an association between the vehicles and the bridge. The subset may include one or more vehicles 210. For example, by analyzing the vehicle categories 292 relative to date and time, the selector module 260 may determine that a first category (e.g., a first combination of type, make, and model) crosses the same bridge “m” number of times each day, and that a second category (e.g., a second combination of type, make, and model) crosses the same bridge “n” number of times each day. Based on this, the selector module 260 may define a first subset that includes vehicles in this first category and a second subset of vehicles in the second category. The categories and vibration data obtained from vehicles in the respective categories may be stored in vehicle set 294 data (as shown in FIG. 2). In this manner, for a respective one of the bridges 215, vibration data obtained from one or more vehicles of a first category is saved in a first vehicle set, vibration data obtained from one or more vehicles of a second category is saved in a second vehicle set, and so on. In this manner, each respective vehicle set 294 for a particular bridge comprises vibration data from similarly classified vehicles that drove over the particular bridge.

At step 450, the system creates machine learning anomaly detection models. In embodiments, the training module 280 uses the telematic vibration sensor data for the identified subset of vehicles as training data to create machine learning anomaly detection models for each bridge. In embodiments, this data is a subset of data from the vehicle only when it is travelling over the location of the bridge of interest.

At step 460, the system filters the data based on context. In embodiments, the filter module 255 filters the data according to the context (e.g., only one vehicle on the bridge) and eliminate potential variations in sensor readings that could be caused by other factors. This may include checking if there was another vehicle at the same location or a weather pattern that might have an impact on an otherwise normal vibration sensor data point. In one example, for the vibration data from the vehicles in a vehicle set 294 for a bridge, the filter module 255 eliminates data from this set when that data was collected at time when there was another vehicle traveling on the bridge or a weather event (such as high wind over a predefined speed). In this manner, after the filtering, the vibration data for a particular vehicle set 294 includes only data from vehicles in that vehicle category when those vehicles were the only vehicles traveling on the bridge during acceptable weather conditions. Continuing the example from above in which the vibration data obtained from one or more vehicles of a first category is saved in a first vehicle set, vibration data obtained from one or more vehicles of a second category is saved in a second vehicle set, the filtering may be used to eliminate noisy data from the first vehicle set and the second vehicle set.

At step 470, the system generates a normal bridge vibration pattern for each category of vehicle for which it has filtered data for this bridge. In embodiments, the normal bridge vibration pattern for a bridge for a category of vehicle is determined by the vibration pattern generator module 265 using the data in the vehicle set for the particular category of vehicle. The normal bridge vibration pattern may be determined using computer-implemented modeling that derives a vibrational response from plural sets of vibration data. For example, the normal bridge vibration pattern may comprise a respective magnitude value for one or more frequencies, e.g., determined from plural data in the vehicle set for the particular category of vehicle using Fourier transform or other technique. In embodiments, the vibration pattern generator module 265 determines a respective normal bridge vibration pattern for each respective category of vehicle in the vehicle set 294, such that a single bridge may have plural different normal bridge vibration patterns for plural different categories of vehicle. In embodiments, the normal bridge vibration patterns are stored in the normal pattern repository 296 (of FIG. 2).

At step 480, the system selects a machine learning algorithm to use to analyze the vehicle vibration telematic data and detect anomalies in vibration patterns from the normal bridge vibration pattern in step 470. In embodiments, the comparison module 270 selects a machine learning algorithm from a predefined set of available machine learning algorithms based on their capabilities, performance, and complexity.

At step 480, the system defines a decision tree for remediation actions to perform in response to a detected anomaly. In embodiments, the alert module 275 defines a mapping or a decision tree for manual and/or autonomous operational procedures/processes that will be executed for each type of anomaly and class of bridge (e.g., notification, create a work order in the asset management system, etc.,).

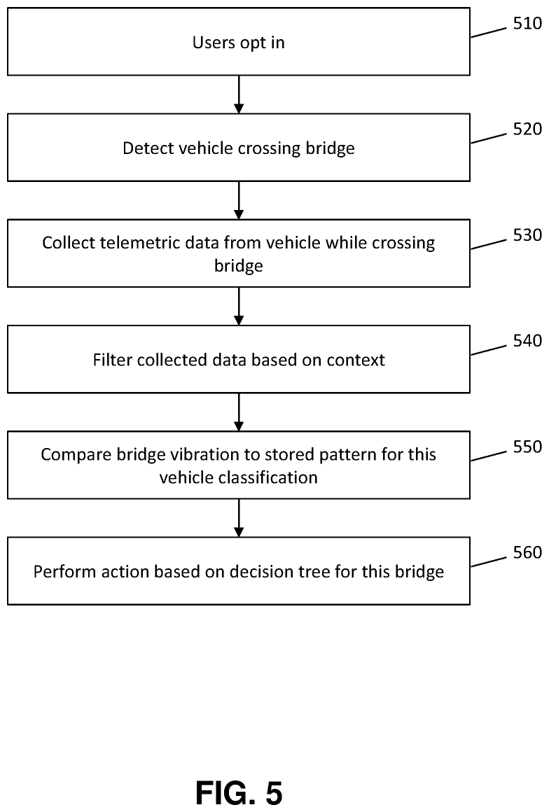

The method of FIG. 5 may be used to implement the real time service of step 330 of FIG. 3. In embodiments the real time service comprises: monitoring the traffic crossing the monitored bridges; collecting the vehicle vibration data with context from the embedded sensors in those selected vehicles; comparing the new received bridge vibration data from same type of vehicle under same context with the generated normal bridge vibration pattern; and sending out an alert if difference reaches a predefined threshold.

At step 510, users of vehicles 210 opt in to having their telemetric data collected for real time service. Users may opt in by being provided with terms and conditions of the real time service and consenting by providing input via a website, app, written paperwork, etc.

At step 520, the system detects one of the vehicles 210 crossing one of the bridges 215. This may be performed in a manner similar to that of step 420, i.e., by the monitor module 240 and based on comparing a location of the vehicle to a location of the bridge to determine when the vehicle is on the bridge.

At step 530, the system collects telemetric data from the vehicle while the vehicle is crossing the bridge. In one example, the system collects telematic data from specific (type, make, and model) or an identified class of vehicles only while the vehicle is travelling over a bridge that is managed, and ingests the vehicle vibration data into the asset monitoring platform. Step 530 may be performed in a manner similar to that of step 420, i.e., by the collector module 245 and using wireless communication to transmit the vibration data of the at least one sensor from the vehicle 210 to the monitoring server 220. Step 530 may include classifying the vehicle into one of the vehicle categories, e.g., by the classifier module 250 and based on the type, make, and model of the vehicle.

At step 540, the system filters the collected data from step 530 based on context. In embodiments, the filter module 255 filters the data by: eliminating data that is collected while another vehicle was on the same bridge and/or during a predefined weather event; and keeps other data that is not eliminated. In this manner, the system eliminates potential variations in sensor readings that could be caused by other factors. This may include checking if there was another vehicle at the same location or a weather pattern that might have an impact on an otherwise normal vibration sensor data point.

At step 550, the system compares the bridge vibration to the stored pattern for this vehicle classification. In one example, the comparison module 270 compares the new received bridge vibration data (e.g., vibration data collected from the vehicle at step 520 and kept (not eliminated) during the filtering at step 540) to the normal bridge vibration pattern for the particular category of vehicle for the vehicle 210 from which the vibration data was collected at step 530. For example, based on the determined classification of the vehicle at step 530 into a vehicle category, the comparison module 270 retrieves, from the normal pattern repository 296, the normal bridge vibration pattern for this bridge for this vehicle category. In this example, the comparison module 270 then compares the vibration data collected at step 530 to the retrieved normal bridge vibration pattern. Based on this comparison, the comparison module 270 may deem that an anomaly exists if the vibration data collected at step 530 differs from the retrieved normal bridge vibration pattern in a predefined way. The predefined way may include, for example, determining that at a particular frequency, the magnitude of the vibration data collected at step 530 exceeds the magnitude of the retrieved normal bridge vibration pattern by more than a predefined amount. In this example, if the magnitudes at the same frequency differ by more than the predefined amount, then the comparison module 270 may deem that an anomaly exists. On the other hand, if the magnitudes at the same frequency differ by less than the predefined amount, then the comparison module 270 may deem that an anomaly does not exist. Other predefined ways may be used to determine an anomaly based on the described comparison.

Alternatively at step 550 the comparison module 270 may determine that an anomaly exists using a machine learning anomaly detection model, such as the model selected at step 480 of FIG. 4. An example of such a machine learning model is a machine learning model that is trained to detect anomalies in time series data. Another example of such a machine learning model comprises extracting features from the raw measurements (e.g., the vibration data associated with the vehicle set 294) corresponding to normal operation. This example comprises using the selected features to train three different models (e.g., a one-class support vector machine (SVM), an isolation forest, and Long Short-Term Memory (LSTM) autoencoder) for anomaly detection. This example comprises using each trained model with the data collected at step 530 to determine whether the bridge vibration associated with the data from step 530 is within normal predefined bounds. Another example of such a machine learning model comprises a model that performs data anomaly detection of bridge structures using convolutional neural network (CNN) based on vibration signals. In this example, the CNN may be trained using the vibration data associated with the vehicle set 294 as corresponding to normal operation. The trained CNN can then be used to predict whether the data collected at step 530 constitutes an anomaly or normal operation.

At step 560, the system performs a remediation action based on a decision tree for this bridge. In embodiments, when an anomaly is detected, the system fetches the corresponding operational remediation action defined in a decision tree or mapping table during the training step and executes the action. These remediation actions can be as simple as sending an alert notification to an authority that is responsible for the maintenance and safety operations of the bridge or creating a service ticket in the asset management solution configured in the setup phase. In embodiments, in response to detecting an anomaly at step 550, the alert module 275 performs a remediation action according to the decision tree from step 490. The decision tree may define different remediation actions for different types or levels of anomaly. For example, the decision tree may define: a first action such as sending an alert to the client device 230 for a first (low) level anomaly; and a second action such as automatically deploying a barrier for a second (high) level anomaly. In another example, when an anomaly is detected in this manner for a bridge, the following actions may be taken in real time: an urgent notification is sent to relevant departments; local safety and policing departments are notified; and entry to the bridge is automatically triggered to be restricted through built-in entrance barriers.

Step 560 may further comprise, in response to detecting an anomaly at a bridge, identifying similar bridges and generating an alert for the similar bridges. In this example, similar bridges may be identified based on bridge information in the data structure, such as by identifying bridges that were built under the same regulations and/or time frame and/or by the same construction company. The alert for the identified related bridges may indicate possible issues for inspection.

The method of FIG. 5 may further comprise measuring environmental and location impacts to identify unique defects in a bridge. Environmental, infrastructural and location factors can significantly impact a bridge's health. Environmental factors, such as wind and sun/solar radiation intensity factors can lead to structural damage and material thermal expansion and contraction cycles, while salt on the road can lead to corrosion in areas where road ice and snow are melted by ice, or the bridge is over a salt-water ocean. Also, areas with poor water drainage can contribute to wear and tear, as well as potential flooding and erosion that can weaken the bridge's foundation. Location factors, such as proximity to hospitals, airports, schools, and other heavy traffic areas require additional attention of authorities as these bridges may be an emergency hub to these locations. In embodiments, the monitoring server 220 is configured to be context-aware of these factors based on IoT engagements and is able to categorize and prioritize such factors into sensor reporting output. For example, if a bridge data indicates that it is near a hospital or in the direct solar radiation with severe weather data like wind and ice, then the reporting threshold would be different than a bridge in a remote area with a perfect four-season weather connecting land to a fishing destination across the river. In the first instance the sensors reporting threshold would be more sensitive to alarm authorities than the second bridge.

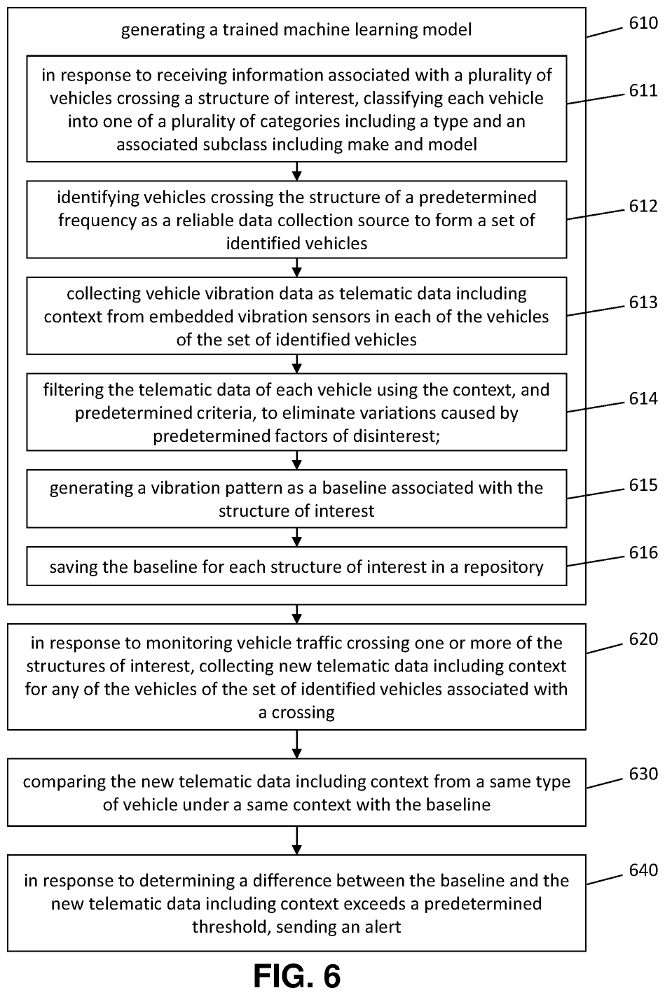

FIG. 6 shows a flowchart of an exemplary computer-implemented process for structural monitoring. In embodiments, the process includes generating a trained machine learning model at step 610, which may include steps 611-616. Step 611 includes, in response to receiving information associated with a plurality of vehicles crossing a structure of interest, classifying each vehicle into one of a plurality of categories including a type and an associated subclass including make and model (e.g., as at step 430). Step 612 includes identifying vehicles crossing the structure of a predetermined frequency as a reliable data collection source to form a set of identified vehicles (e.g., as at step 440). Step 613 includes collecting vehicle vibration data as telematic data including context from embedded vibration sensors in each of the vehicles of the set of identified vehicles (e.g., as at step 420). Step 614 includes filtering the telematic data of each vehicle using the context, and predetermined criteria, to eliminate variations caused by predetermined factors of disinterest (e.g., as at step 460). Step 615 includes generating a vibration pattern as a baseline associated with the structure of interest (e.g., as at step 470). Step 616 includes saving the baseline for each structure of interest in a repository (e.g., as at step 470).

At step 620, in response to monitoring vehicle traffic crossing one or more of the structures of interest, the system collects new telematic data including context for any of the vehicles of the set of identified vehicles associated with a crossing (e.g., as at steps 520 and 530).

At step 630, the system compares the new telematic data including context from a same type of vehicle under a same context with the baseline (e.g., as at step 550).

At step 640, in response to determining a difference between the baseline and the new telematic data including context exceeds a predetermined threshold, the system sends an alert (e.g., as at step 560).

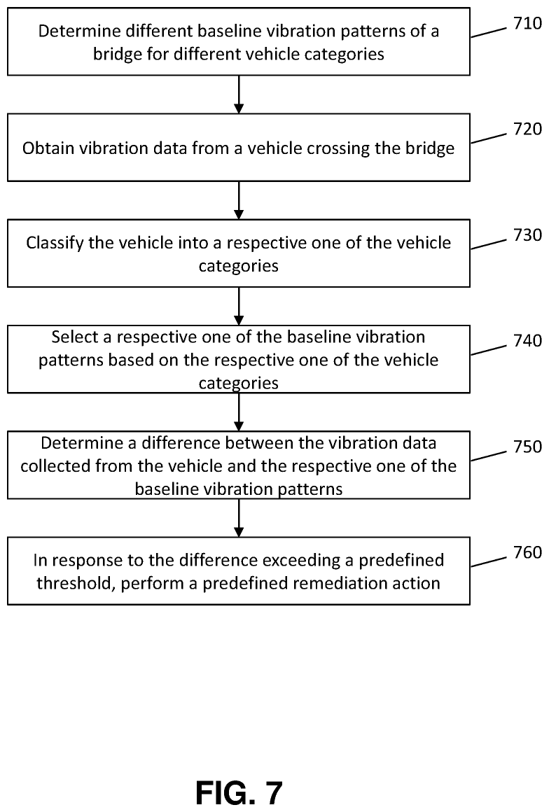

FIG. 7 shows a flowchart of an exemplary method in accordance with aspects of the present invention. Steps of the method may be carried out in the environment of FIG. 2 and are described with reference to elements depicted in FIG. 2.

At step 710, the system determines different baseline vibration patterns of a bridge for different vehicle categories. Step 710 may be performed, for example, in accordance with aspects of one or more of steps 420-470 of FIG. 4.

At step 720, the system obtains vibration data from a vehicle crossing the bridge. Step 720 may be performed, for example, in accordance with aspects of one or more of steps 520 and 530 of FIG. 5.

At step 730, the system classifies the vehicle into a respective one of the vehicle categories. Step 730 may be performed, for example, in accordance with aspects of one or more of step 430 of FIG. 4 and step 530 of FIG. 5.

At step 740, the system selects a respective one of the baseline vibration patterns based on the respective one of the vehicle categories. Step 740 may be performed, for example, in accordance with aspects of step 550 of FIG. 5. For example, after determining the vehicle category for the vehicle based on classifying the vehicle, the monitoring server 220 may retrieve the normal bridge vibration pattern for the determined category of vehicle from the normal pattern repository 296.

At step 750, the system determines a difference between the vibration data collected from the vehicle and the respective one of the baseline vibration patterns. Step 750 may be performed, for example, in accordance with aspects of step 550 of FIG. 5. In one example, the comparison module 270 determines a difference in magnitude of the vibration data collected from the vehicle and the respective one of the baseline vibration patterns. In this example, the difference in magnitude comprises the difference between: (i) the magnitude of the vibration data collected from the vehicle at a predefined frequency, and (ii) the magnitude of the normal bridge vibration pattern at the same predefined frequency.

At step 760, in response to the difference exceeding a predefined threshold, the system performs a predefined remediation action. Step 750 may be performed, for example, in accordance with aspects of step 560 of FIG. 5.

In embodiments of the method of FIG. 7, the vibration data is collected by at least one sensor at a suspension of the vehicle, e.g., as described at step 420 of FIG. 4.

In embodiments of the method of FIG. 7, the vehicle is classified based on type, make, and model of the vehicle.

In embodiments of the method of FIG. 7, the different baseline vibration patterns are determined using vibration data from plural vehicles passing over the bridge during a training phase.

In embodiments of the method of FIG. 7, the method comprises filtering the vibration data from the plural vehicles based on context. This may be performed, for example, in accordance with aspects of step 460 of FIG. 4.

In embodiments of the method of FIG. 7, the predefined remediation action is selected from a set of plural different predefined remediation actions using a decision tree and based on an amount of the difference. This may be performed, for example, in accordance with aspects of step 560 of FIG. 5.

In embodiments of the method of FIG. 7, the predefined threshold is based on environmental impacts or location impacts associated with the bridge. This may be performed, for example, in accordance with aspects of step 560 of FIG. 5.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a processor set, different baseline vibration patterns of a bridge for different vehicle categories;
obtaining, by the processor set, vibration data from a vehicle crossing the bridge;
classifying, by the processor set, the vehicle into a respective one of the vehicle categories;
selecting, by the processor set, a respective one of the baseline vibration patterns based on the respective one of the vehicle categories;
determining, by the processor set, a difference between the vibration data collected from the vehicle and the respective one of the baseline vibration patterns; and
in response to the difference exceeding a predefined threshold, performing, by the processor set, a predefined remediation action.

2. The computer-implemented method of claim 1, wherein the vibration data is collected by at least one sensor installed on the vehicle.

3. The computer-implemented method of claim 1, wherein the vehicle is classified based on type, make, and model of the vehicle.

4. The computer-implemented method of claim 1, wherein the different baseline vibration patterns are determined using vibration data from plural vehicles passing over the bridge during a training phase.

5. The computer-implemented method of claim 4, further comprising filtering the vibration data from the plural vehicles based on context.

6. The computer-implemented method of claim 1, wherein the predefined remediation action is selected from a set of plural different predefined remediation actions using a decision tree and based on an amount of the difference.

7. The computer-implemented method of claim 1, wherein the predefined threshold is based on environmental impacts or location impacts associated with the bridge.

8. A computer program product comprising one or more computer readable storage media having program instructions collectively stored on the one or more computer readable storage media, the program instructions executable to:
determine different baseline vibration patterns of a bridge for different vehicle categories;
obtain vibration data from a vehicle crossing the bridge;
classify the vehicle into a respective one of the vehicle categories;
select a respective one of the baseline vibration patterns based on the respective one of the vehicle categories;
determine a difference between the vibration data collected from the vehicle and the respective one of the baseline vibration patterns; and
in response to the difference exceeding a predefined threshold, perform a predefined remediation action.

9. The computer program product of claim 8, wherein the vibration data is collected by at least one sensor installed on the vehicle.

10. The computer program product of claim 8, wherein the vehicle is classified based on type, make, and model of the vehicle.

11. The computer program product of claim 8, wherein the different baseline vibration patterns are determined using vibration data from plural vehicles passing over the bridge during a training phase.

12. The computer program product of claim 11, wherein the program instructions are executable to filter the vibration data from the plural vehicles based on context.

13. The computer program product of claim 8, wherein the predefined remediation action is selected from a set of plural different predefined remediation actions using a decision tree and based on an amount of the difference.

14. The computer program product of claim 8, wherein the predefined threshold is based on environmental impacts or location impacts associated with the bridge.

15. A system comprising:
a processor set, one or more computer readable storage media, and program instructions collectively stored on the one or more computer readable storage media, the program instructions executable to:
determine different baseline vibration patterns of a bridge for different vehicle categories;
obtain vibration data from a vehicle crossing the bridge;
classify the vehicle into a respective one of the vehicle categories;
select a respective one of the baseline vibration patterns based on the respective one of the vehicle categories;
determine a difference between the vibration data collected from the vehicle and the respective one of the baseline vibration patterns; and
in response to the difference exceeding a predefined threshold, perform a predefined remediation action.

16. The system of claim 15, wherein the vibration data is collected by at least one sensor installed on the vehicle.

17. The system of claim 15, wherein the vehicle is classified based on type, make, and model of the vehicle.

18. The system of claim 15, wherein the different baseline vibration patterns are determined using vibration data from plural vehicles passing over the bridge during a training phase.

19. The system of claim 18, wherein the program instructions are executable to filter the vibration data from the plural vehicles based on context.

20. The system of claim 15, wherein the predefined remediation action is selected from a set of plural different predefined remediation actions using a decision tree and based on an amount of the difference.

21. The system of claim 15, wherein the predefined threshold is based on environmental impacts or location impacts associated with the bridge.

22. A computer-implemented method, comprising:
generating a trained machine learning model by:
in response to receiving information associated with a plurality of vehicles crossing a structure of interest, classifying each vehicle into one of a plurality of categories including a type and an associated subclass including make and model;
identifying vehicles crossing the structure of a predetermined frequency as a reliable data collection source to form a set of identified vehicles;
collecting vehicle vibration data as telematic data including context from embedded vibration sensors in each of the vehicles of the set of identified vehicles;
filtering the telematic data of each vehicle using the context, and predetermined criteria, to eliminate variations caused by predetermined factors of disinterest;
generating a vibration pattern as a baseline associated with the structure of interest; and
saving the baseline for each structure of interest in a repository;
in response to monitoring vehicle traffic crossing one or more of the structures of interest, collecting new telematic data including context for any of the vehicles of the set of identified vehicles associated with a crossing;
comparing the new telematic data including context from a same type of vehicle under a same context with the baseline; and
in response to determining a difference between the baseline and the new telematic data including context exceeds a predetermined threshold, sending an alert.

23. The computer implemented method of claim 22, wherein the alert is selected from a set of plural different predefined alerts using a decision tree and based on an amount of the difference.

24. A system comprising:
a processor set, one or more computer readable storage media, and program instructions collectively stored on the one or more computer readable storage media, the program instructions executable to:
generate a trained machine learning model by:
in response to receiving information associated with a plurality of vehicles crossing a structure of interest, classify each vehicle into one of a plurality of categories including a type and an associated subclass including make and model;
identify vehicles crossing the structure of a predetermined frequency as a reliable data collection source to form a set of identified vehicles;
collect vehicle vibration data as telematic data including context from embedded vibration sensors in each of the vehicles of the set of identified vehicles;
filter the telematic data of each vehicle using the context, and predetermined criteria, to eliminate variations caused by predetermined factors of disinterest;
generate a vibration pattern as a baseline associated with the structure of interest; and
save the baseline for each structure of interest in a repository;
in response to monitoring vehicle traffic crossing one or more of the structures of interest, collect new telematic data including context for any of the vehicles of the set of identified vehicles associated with a crossing;
compare the new telematic data including context from a same type of vehicle under a same context with the baseline; and
in response to determining a difference between the baseline and the new telematic data including context exceeds a predetermined threshold, send an alert.

25. The system of claim 24, wherein the alert is selected from a set of plural different predefined alerts using a decision tree and based on an amount of the difference.
